(19) United States
(12) Patent Application Publication
(10) Pub. No.: US 2014/0362403 A1
(43) Pub. Date: Dec. 11, 2014

(54) IMAGE FORMING APPARATUS

(71) Applicant: Sharp Kabushiki Kaisha, Osaka (JP)

(72) Inventors: Hidenobu MANDAI, Osaka (JP); Yoshitaka OKAHASHI, Osaka (JP); Shuichi MOCHIZUKI, Osaka (JP)

(73) Assignee: Sharp Kabushiki Kaisha, Osaka (JP)

(21) Appl. No.: 14/294,322

(22) Filed: Jun. 3, 2014

(30) Foreign Application Priority Data
Jun. 5, 2013 (JP) 2013-118603
Mar. 18, 2014 (JP) 2014-054346

(51) Int. Cl. H04N 1/00; G06F 1/18

(52) U.S. Cl. CPC H04N 1/00411; H04N 1/00384; G06F 1/182
USPC 358/1.15

(57) ABSTRACT

An image forming apparatus includes a housing, an input operating device, and a display device. The input operating device includes an input operating portion formed on an upper face side of the input operating device. The input operating device is arranged on a front face side of a top face of the housing. The input operating device is configured so that a use position can be changed along the top face of the housing. The display device includes a display portion formed on a front face side. The input operating device can cause the display portion to pivot to a position in which the display portion can be easily viewed.

### CROSS REFERENCE

This Nonprovisional application claims priority under 35 U.S.C. §119(a) on Patent Application No. 2013-118603 filed in Japan on Jun. 5, 2013 and on Patent Application No. 2014-054346 on Mar. 18, 2014, the entire contents of which are hereby incorporated by reference.

### BACKGROUND OF THE INVENTION

The present invention relates to an image forming apparatus such as a copying machine, a printer, a facsimile machine, or a multifunctional machine including at least two functions of the copying machine, the printer, and the facsimile machine.

An image forming apparatus such as a multifunctional machine has an operating display portion for receiving various types of settings from a user and an instruction of start of an image forming process. The operating display portion has a display portion that displays a menu and the details of settings, and an operating portion with which a user inputs a set value and the like. The display portion is a touch panel and the user can also operate the image forming apparatus by pressing a key (software key) displayed on the display portion.

In recent years, image forming apparatuses have had multiple functions, and some of the image forming apparatuses have a function of sending a document scanned by an image reading device by attachment to e-mail, to a destination party. In a case of such image forming apparatuses, it is necessary to input the e-mail address of the destination party, which may require time-consuming input because, in general, an e-mail address not only consists of comparatively many characters ranging from about ten characters to about tens of characters but also includes many letter types such as an alphabet, a number, and a symbol.

In order to solve such a problem, there is an operating display portion that displays a software keyboard in which software keys are arranged in an array the same as the array of keyboards generally used in personal computers. By using such a software keyboard, a user can easily perform an input operation with both hands, which makes it possible for the user to quickly input a character string even if the character string is like an e-mail address consisting of a plurality of letter types.

However, the operation of the software keyboard by using a touch panel is poor in readiness and the usability of the software keyboard, even including a sensational aspect, does not come up to the usability of a hardware keyboard.

In view of the foregoing, Japanese Patent Laid-Open Publication No. 2006-347090 (Patent Literature 1) discloses an image forming apparatus including an operating display portion in which a hardware keyboard and a display are unitized and proposes that the operating display portion should be fixed to a support arm through a pivoting member, the support arm being provided so as to be in parallel to an installation face of a housing of the image forming apparatus and protrude from the housing. The image forming apparatus further includes fixing member configured so as to be capable of causing the operating display portion to pivot within a range from substantially perpendicular to horizontal to the installation face of the image forming apparatus. This configuration makes it possible for users to adjust an angle of the operating display portion in accordance with an eye level of each of the users even when the position of the eye level of each of the users changes because of differences in height or the like, so that operability and visibility without uncomfortable feeling are realized.

However, in the invention described in Patent Literature 1, since the operating display portion in which the hardware keyboard and the display are unitized is supported by the support arm protruded in parallel with the installation face from the housing of the image forming apparatus, the installation space of the image forming apparatus becomes large. In addition, the operating display portion is supported by an unstable support arm as a foundation, thus causing poor operability.

The present invention has been made in view of such a situation and is directed to providing an image forming apparatus capable of: installing in a space saving manner an input operating device configured so that a use position of the input operating device can be changed; and ensuring visibility of a display portion of a display device in any use position while not impairing operability of the input operating device.

### SUMMARY OF THE INVENTION

An image forming apparatus according to preferred embodiments of the present invention includes a housing, an input operating device, and a display device. The input operating device has an input operating portion on an upper face side of the input operating device and is arranged on a front face side of a top face of the housing. The input operating device is configured so that a position of the input operating portion can be changed. The display device has a display portion on a front face side of the display device, and is arranged at a position higher than the top face of the housing and more backward than the input operating device. The display device is configured so that a position of the display portion can be changed.

The foregoing and other features and attendant advantages of the present invention will become more apparent from the reading of the following detailed description of the invention in conjunction with the accompanying drawings.

### BRIEF DESCRIPTION OF THE DRAWINGS

FIG. 1 is a perspective view showing an appearance of an image forming apparatus according to a preferred embodiment of the present invention.

FIG. 2 is a perspective view showing a top face of a housing of the image forming apparatus.

FIG. 3 is a plan view showing the top face of the housing of the image forming apparatus.

FIG. 4 is a perspective view showing an input operating device arranged on the top face of the housing of the image forming apparatus.

FIG. 5 is a side view showing a display device arranged on the top face of the housing of the image forming apparatus.

FIG. 6 is a perspective view showing a pivoting mechanism of the input operating device in a disassembled state.

FIG. 7 is a side view schematically showing an input operating device according to another preferred embodiment of the present invention.

FIG. 8A is a front view showing the pivoting mechanism of the input operating device and FIG. 8B is a side view showing the rotating mechanism of the input operating device.

FIG. 9 is a view showing another example of an input operating device.

### DETAILED DESCRIPTION OF THE INVENTION

To begin with, a description will be made of a first preferred embodiment of an image forming apparatus according to the present invention.

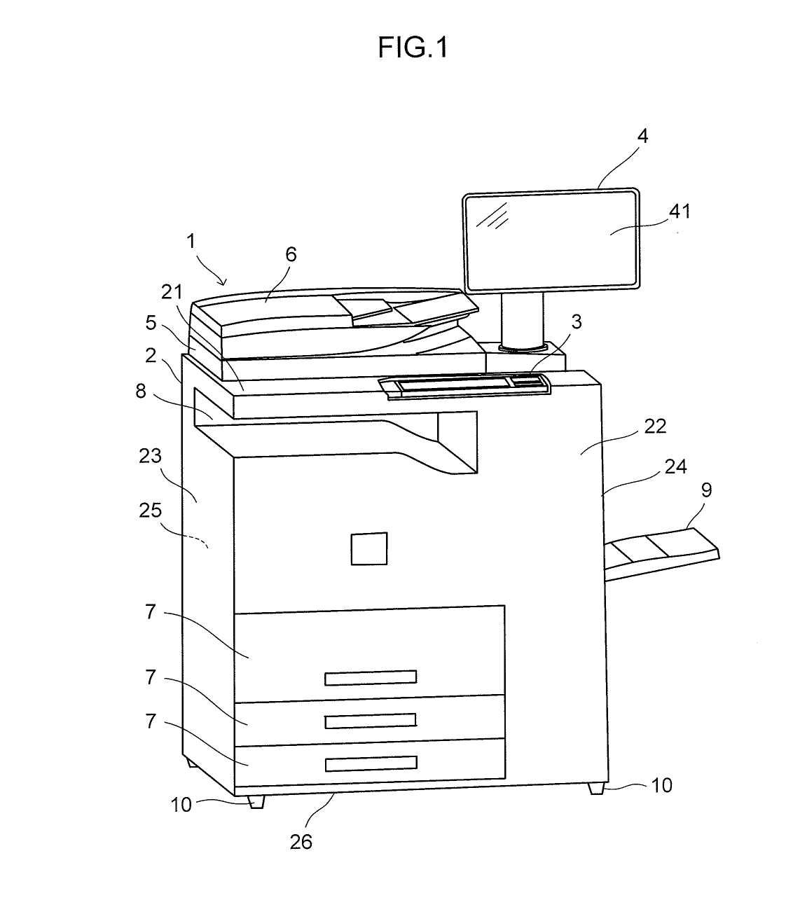

As shown in FIG. 1, generally described, the image forming apparatus 1 includes a housing 2 in which a not-shown photoreceptor drum, a sheet supply portion, an electrostatic latent image forming unit, a developing unit, a transfer unit, a fixing unit, and a sheet discharge portion are provided. The photoreceptor drum and the transfer unit are arranged along a predetermined sheet feed path extending from the sheet supply portion to the sheet discharge portion. The housing 2 includes an input operating device 3 and a display device 4. The display device 4 is equipped with a display portion 41.

The housing 2 has a substantially rectangular parallelepiped shape as a whole and the appearance of the housing 2 is formed of a top face 21, a front face 22, a left side face 23, a right side face 24, a rear face 25, and a bottom face 26. On the top face 21 of the housing 2 is installed a non-shown document platen. In an opening and closing cover 5 that covers the document platen is arranged an Automatic Document Feeder (ADF) 6. The document platen and the ADF 6 are properly used depending on the type of a document or the number of sheets.

In a lower part of the housing 2 is fitted a multi stage type sheet supply cassette 7 so as to be freely pulled out. The sheet supply cassette 7 has a handle arranged on the front face 22 side of the housing 2. Immediately below the top face 21 of the housing 2 is formed an in-body sheet discharge portion 8 as a hollow that is opened to the front face 22 of the housing 2 and the left side face 23 of the housing. On the right side face 24 of the housing 2 is provided a manual sheet supply tray 9 of an opening and closing type. The bottom face 26 of the housing 2 is provided with a plurality of support legs 10 in appropriate positions such as four corners, for example. The image forming apparatus 1 is supported by the support legs 10 on a floor face.

The image forming apparatus according to the present invention has characteristics in: the top face 21 of the housing 2, and the peripheral structure of the top face 21. The following is a detailed description of preferred embodiments of the present invention.

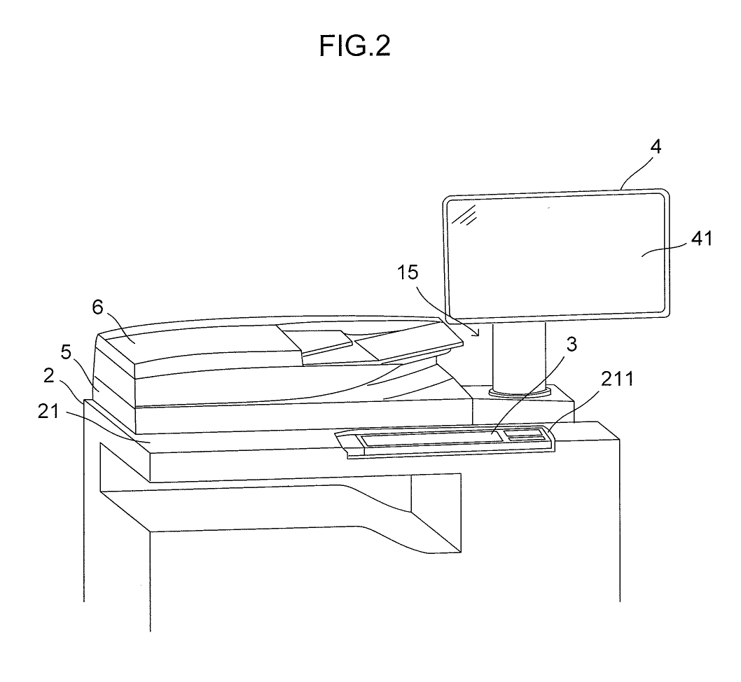

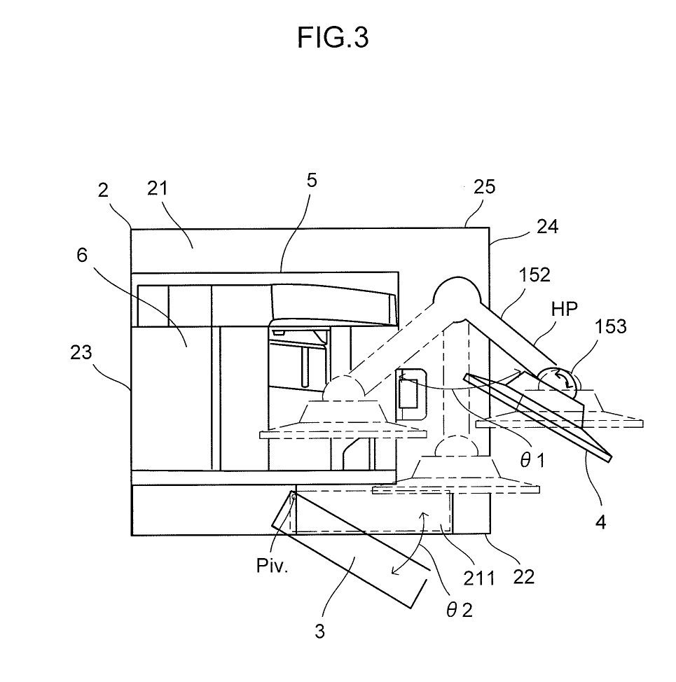

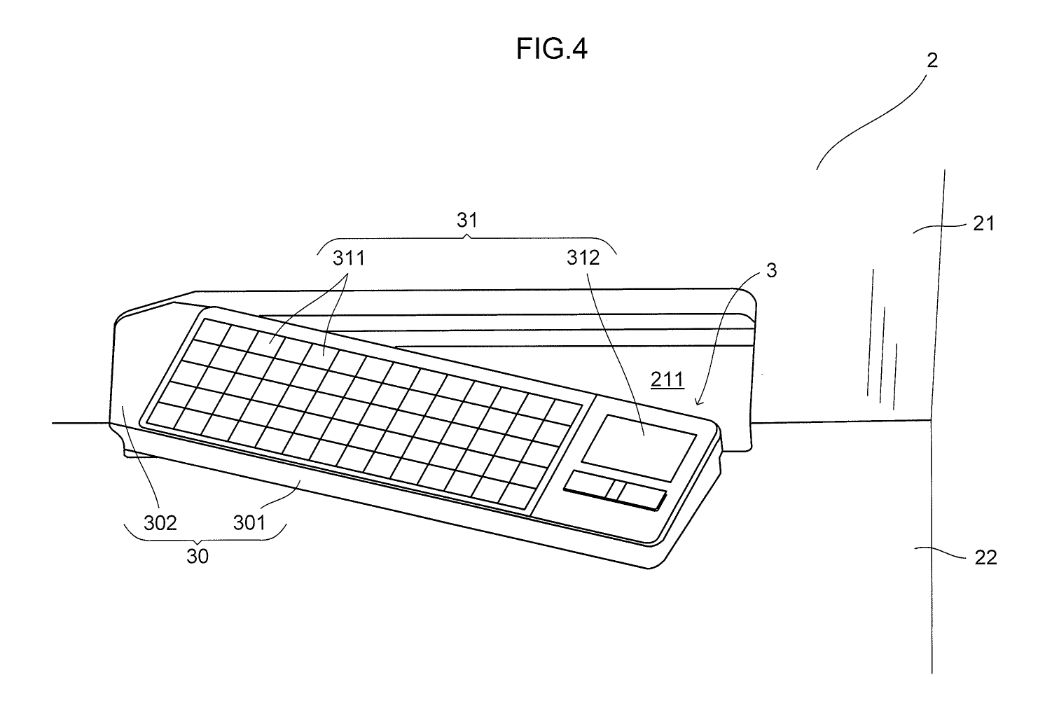

As shown in FIG. 2 and FIG. 3, an input operating device 3 is arranged on the front face 22 side of the top face 21 of the housing 2. The opening and closing cover 5 and the ADF 6 occupy most of the area of the top face 21 of the housing 2, and, as shown in FIG. 4, this occupied area is formed so as to be located eccentrically on the left side face 23 side of the top face 21 of the housing 2. Therefore, on the top face 21 of the housing 2, an area spread in a U-shape over the front face 22 side, the right side face 24 side, and the rear face 25 side is comparatively free and can be used as a space for arranging an additional component and unit.

As shown in FIG. 4, in a substantially right half of the area on the front face 22 side of the top face 21 of the housing 2 is formed an open recessed stage 211 that is recessed so as to be one stage lower. The recessed stage 211 may also be a recess in which a plate-shaped input operating device 3 to be described below is stored in a perfectly fitting manner. The recessed stage 211 forms a part of the top face 21 of the housing 2. The left side face of the recessed stage 211 has a non-shown opening that is wide open and leads to a space in the housing 2, and the input operating device 3 is provided on the recessed stage 211 in a manner so that a widthwise end portion (left end portion in FIG. 4) in a front face view is inserted from this opening.

The input operating device 3, of which the periphery is surrounded by a plate-shaped frame body 30, has an input operating portion 31 on the upper face side of the input operating device 3. The input operating device 3 is, as an example, a hardware keyboard in which a plurality of hardware keys 311 that correspond to the input of a character, a number, a symbol, and the like are arrayed on the input operating portion 31. According to the preferred embodiment of the present invention, to the input operating portion 31 is also attached a pointing device 312 that corresponds to a sensuous operation using a finger, next to a group of the hardware keys 311.

The frame body 30 of the input operating device 3 is in a shape in which a flank portion 302 that serves as an insertion margin to the opening and a pivot margin of the recessed stage 211 is extended on the widthwise end side (left end side in FIG. 4) of a body portion 301 formed on the input operating portion 31. The flank portion of the frame body of the input operating device 3 includes a tip end portion (not shown) inserted into the opening of the recessed stage 211, and the tip end portion includes a wide open space, so that a non-shown harness to connect the input operating device 3 and a non-shown control board in the housing 2 can be routed through the space without being exposed.

The input operating device 3 is arranged so as to pivot within a predetermined range along the top face 21 of the housing 2 (that is, the bottom floor of the recessed stage 211) around a non-shown pivot point Piv. that is set at the tip end portion of the flank portion 302 of the frame body 30. Accordingly, the input operating device 3 may preferably be configured to be freely displaced in a plan view.

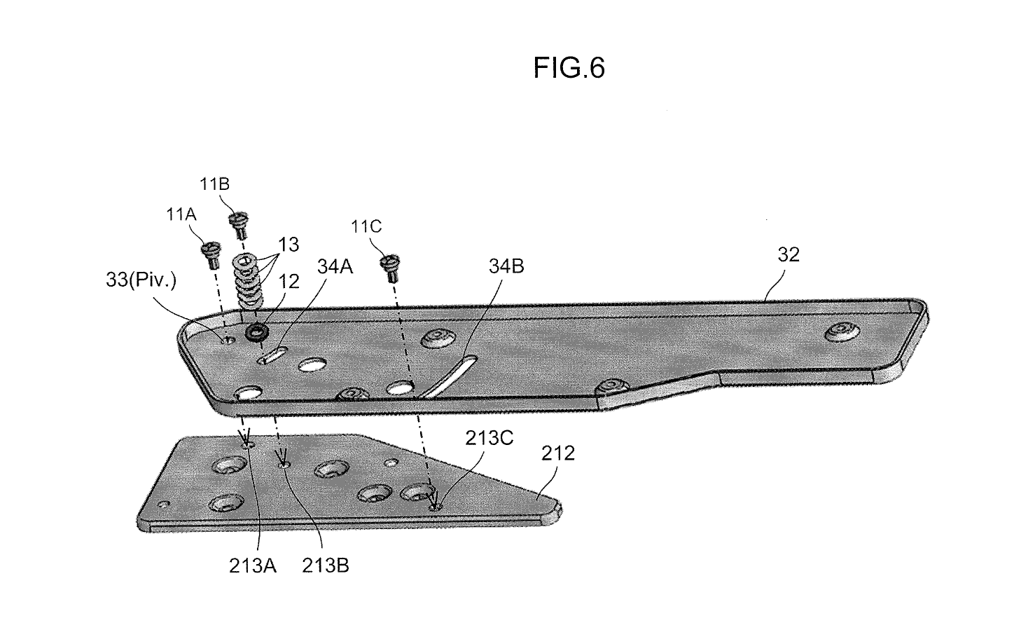

FIG. 6 shows a pivoting mechanism of the input operating device 3 in a disassembled state. In order to enable pivoting movement of the input operating device 3, a part of the bottom floor of the recessed stage 211 is replaced by a floor board 212 as shown in the figure. The part that is replaced by the floor board 212 is a part close to the pivot point, and even if the recessed stage 211 is exposed in this part, the floor board 212 is not noticeable because of being hid under the input operating device 3 and not being exposed. The floor board 212 includes three mounting holes 213A, 213B, and 213C to which screws 11A, 11B, and 11C are mounted.

A part of the bottom face of the frame body 30 of the input operating device 3 is also replaced by a bottom plate 32 as shown in the figure. The bottom plate 32, correspondingly to the mounting holes, may preferably be provided with one round hole 33, and two circular arc holes 34A and 34B that restrict a pivoting range. Into the round hole 33 is inserted the screw 11A, which defines the pivot point Piv. of the input operating portion 31. Into the circular arc holes 34A and 34B are inserted the screws 11B and 11C, respectively, which restrict the pivoting range (see reference symbol θ2 in FIG. 3) of the input operating portion 31. The circular arc holes 34A and 34B and the screws 11B and 11C correspond to a restricting member of the present invention.

Since, by restricting the pivoting range of the input operating device 3, the top face 21 of the housing 2 (that is, the bottom floor of the recessed stage 211) may function as a foundation of the input operating device 3 at any position within the pivoting range, the workability of the input operating portion 31 is stabilized.

Between the screw 11B that is inserted into the circular arc hole 34A and the bottom plate 32 are held a washer 12 and a plate spring 13. The washer 12 and the plate spring 13 are examples of a fixing unit of the present invention. The fixing unit, by pressing the bottom plate 32 to the floor board 212 side, raises frictional force (in particular, static frictional force). This enables the input operating device 3 to be fixed in an arbitrary position within the pivoting range, so that the workability of the input operating portion 31 is further stabilized. It is to be noted that the plate spring 13 may be replaced by a coil spring.

The pivot point Piv. of the input operating device 3 is located at the tip end portion of the flank portion of the frame body, so that the input operating device 3 is inserted to the depth of the opening of the recessed stage 211. This makes it possible to increase a pivot stroke even within a small pivoting range and to move the input operating device 3 dynamically.

By the pivoting mechanism, the use position of the input operating device 3 can be changed. In other words, the angle of the input operating portion 31 may preferably be changed. Since the input operating device 3 is supported by a stable foundation (the top face 21 of the housing 2), even if the use position is changed, the operability is not reduced. In addition, since the protrusion of the input operating device 3 to the outside of the housing 2 is small even if the use position is displaced, the input operating device 3 of a movable type can be installed in a space-saving manner.

As shown in FIG. 2, the display device 4 includes a display portion 41 formed on the front face side of the display device 4. As for the display device 4, a thin display may preferably be used as an example. The display device 4 is supported by using a support structure 15 installed to the back side of the end portion (the right side face 24 side) of the top face 21 of the housing 2. The display portion 4 is arranged at a position higher than the top face 21 of the housing 2 and more backward than the input operating device 3. It should be noted that an arrangement position of the display device 4 is not necessarily limited to the end portion of the top face 21 of the housing 2.

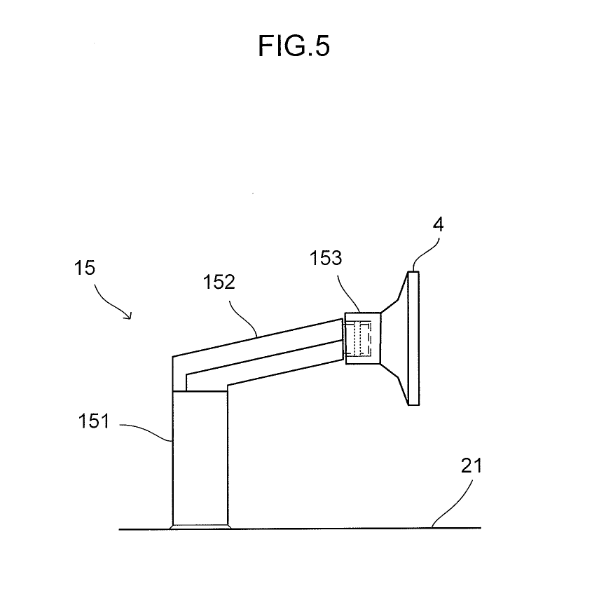

As shown in FIG. 5, the support structure 15 is equipped with a support post 151, a support arm 152, and a pivoting member 153. The support arm 152 is pivotally provided at an upper end of the firmly fixed support post 151. The pivoting member 153 is attached to a tip of the support arm 152 and is coupled to the rear face of the display device 4.

As an arrow θ1 in FIG. 3 shows, the pivoting range of the support arm 152 may be restricted by any method. Moreover, braking of the pivoting movement of the support arm 152 can prevent the display device 4 from moving to an unexpected position at the moment such as when the body of a user collides with the display device 4.

The pivoting range of the pivoting member 153 may be restricted by any method. Furthermore, the braking of the pivoting movement of the pivoting member 153 includes a braking unit that fixes the display device 4. While, in this preferred embodiment of the present invention, the pivoting member 153 is a pivoting member corresponding to pivoting movement in the horizontal direction (so-called yaw movement), the present invention is not limited to this. As the pivoting member 153, a pivoting member that enables two-way pivoting movement in which horizontal pivoting movement is combined with vertical pivoting movement (so-called pitch movement) may be preferably used, so that free pivoting movement of the display device 4 can be realized.

By using this support structure 15, the use position of the display device 4 can variously be changed in a combination of the pivoting movement of the support arm 152 and the pivoting movement of the pivoting member 153. The use position of display device 4 is specifically defined by the angle of the display portion 41 and is more specifically defined by the line of sight and the viewing angle that are targeted at the display portion 41, on the basis of a user who stands in front of the input operating device 3.

The input operating device 3 is made to pivot to a position in which the display portion 41 can easily be viewed. A specific example of the position in which the display portion 41 can be easily viewed includes a position in which the input operating device 3 faces right to the display portion 41.

As shown in FIG. 3, the pivoting range of the support arm 152 is, as an example, an angle obtained by equally allocating a swing angle to both sides divided by a bisector in a direction in which the support arm 152 faces the front face 22 of the housing 2. At this time, the reference position (home position HP) of the display device 4 is set at a position (see the solid line position of the support arm 152 in FIG. 3) that is closer to an end (right end in FIG. 3) of the pivoting range of the support arm 152. The reason is that the bulky display device 4 is not located over the top face 21 of the housing 2 in this home position HP, which does not interfere in the opening and closing of the opening and closing cover 5. In addition, a user can operate the input operating portion 31 while looking at the display portion 41 by placing the display device 4 and the input operating device 3 not too close or too far, that is, by keeping an appropriate distance between the display device 4 and the input operating device 3.

Examples of an advantage that the display device 4 can be moved from the home position HP to the front face 22 side of the housing 2 include a case in which, when a paper jam occurs in the housing 2, and a user opens a door on the right side face 24 of the housing 2 and performs a jam process, the user can be prevented from hitting the head against the display device 4.

In view of frequent use of the display device 4 in this home position HP, it is desirable that the pivot point Piv. of the input operating device 3 should be set at the widthwise end portion (left end portion in FIG. 3) located far from the installation position of the support structure 15 in the top face 21 of the housing 2. The reason is that, if the display portion 41 of the display device 4 set at the home position HP is always leaned to the input operating device 3 side (see the solid line position of the display device 4 in FIG. 3), only by pulling out the right end portion of the input operating device 3 from the recessed stage 211 to the front side, the input operating device 3 can quickly be faced to the display portion 41. Moreover, this design can be reasonable in that a user rarely forgets to return the input operating device 3 back to the recessed stage 211 after finishing work.

According to a second preferred embodiment of the present invention, the display portion 41 may preferably be equipped with a function of a touch panel. Input of the mode selections such as copying, scanning, and printing, or the like by a touch key is made from the display portion 41 while input of an e-mail address used when a function of sending a document scanned by a document reading device (not shown) by attachment to e-mail, to a destination party is used, or the like is made from the input operating portion 31.

According to a third preferred embodiment of the present invention, the input operating device 3 may preferably be configured so that an angle of inclination of the input operating portion 31 with respect to the top face 21 of the housing 2 is freely changed within a predetermined range.

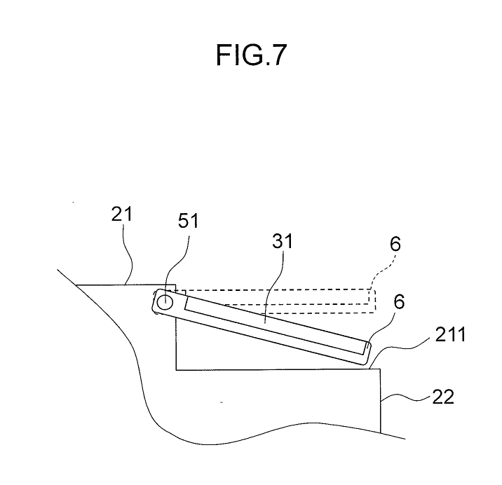

As shown in FIG. 7, the rear face side of the input operating device 3 is attached to the top face 21 of the housing 2 so that the input operating device 3 is arranged above the recessed stage 211 of the top face 21 of the housing 2. The input operating device 3 is configured to pivot between a horizontal position indicated by a dashed line and an inclination position indicated by a solid line so as to keep the horizontal position, the inclination position, and an arbitrary position between the horizontal position and the inclination position.

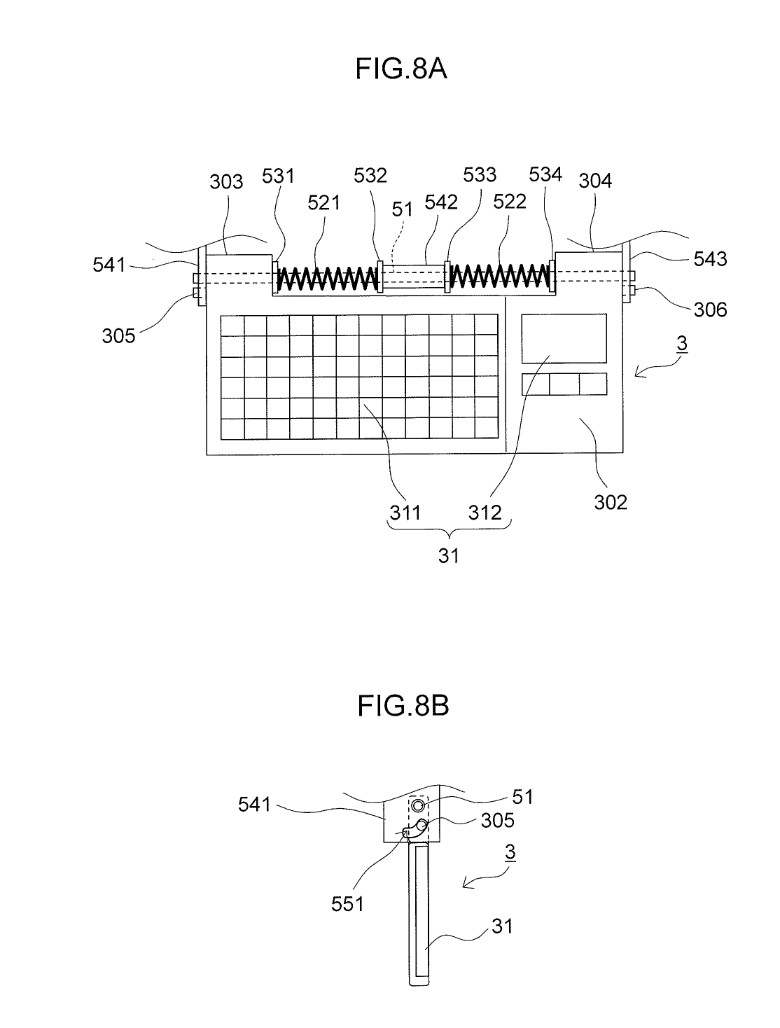

Specifically, as shown in FIG. 8A, the input operating device 3 is equipped with a pivot shaft 51, springs 521 and 522 which are compression coil springs, and washers 531 to 534 and includes projections 303 and 304 that project from the opposite end portions to the rear face side in the front view of the input operating portion 31.

The projections 303 and 304 include a through hole (not shown) for being penetrated by the pivot shaft 51 and, in order to integrally pivot with the pivot shaft 51, the pivot shaft 51 is firmly fixed to the through hole. The housing 2 includes frames 541 to 543 in which a bearing hole (not shown) is formed to support the pivot shaft 51 pivotally, and the pivot shaft 51 is fitted into the bearing hole through a bearing (not shown). Accordingly, the input operating device 3 is formed so as to freely pivot with the pivoting movement of the pivot shaft 51 and is supported by the housing 2.

Moreover, between the projection 303 and the frame 542 are arranged the washer 531, the spring 521, and the washer 532, and between the frame 542 and the projection 304 are arranged the washer 533, the spring 522, and the washer 534. This biases the spring 521 in a direction in which the projection 303 and the frame 541 are separated from each other and biases the spring 522 in a direction in which the projection 304 and the frame 543 are separated from each other, so that the input operating device 3 can keep the horizontal position, the inclination position, and an arbitrary position between the horizontal position and the inclination position. The springs 521 and 522 and the washers 531 to 534 are examples of a fixing unit of the present invention.

Furthermore, the input operating device 3 includes projections 305 and 306 that project from the opposite end portions to the outside in the front view. The projections 305 and 306 may be screws, for example. The frame 541, as shown in FIG. 8B, includes a circular arc hole 551 and the circular arc hole 551 is penetrated by the projection 305. The frame 543 as well as the frame 541 also includes a circular arc hole (not shown) and the circular arc hole is penetrated by the projection 306. This restricts the pivoting range of the input operating device 3 within a predetermined range. The circular arc hole 551, the circular arc hole of the frame 543, and the projections 305 and 306 correspond to a restricting member of the present invention. It is to be noted that at least one of the circular arc hole 551 and the circular arc hole of the frame 543 may preferably be formed and that the projections 305 and 306 may preferably be provided corresponding to the circular arc holes.

In addition, the frames 541 and 542 may include, in place of the circular arc hole, a plurality of holes formed in parallel with one another in an arc-like shape in at least one of the frames. Accordingly, the input operating device 3, by fitting the projections 305 and 306 into any of the plurality of holes, restricts the pivoting range and can keep the horizontal position, the inclination position, and one or more predetermined positions between the horizontal position and the inclination position.

As described above, according to the position of the display portion 41 of the display device 4, the position of the input operating portion 31 of the input operating device 3 can be displaced. Therefore, the visibility of the display portion 41 of the display device 4 is ensured while the operability of the input operating portion 31 of the input operating device 3 is not impaired.

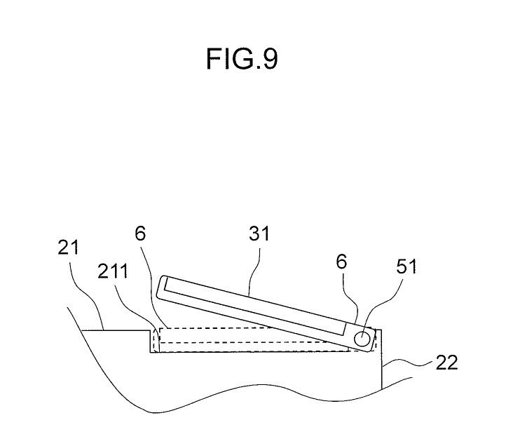

It should be noted, as shown in FIG. 9, that the front face side of the input operating device 3 may be attached to the recessed stage 211 of the top face 21 of the housing 2 and that the input operating device 3 may be configured so as to freely pivot between the horizontal position indicated by a dashed line and the inclination position indicated by a solid line. Moreover, while having been supported at opposite ends by the frames 541 to 543, the input operating device 3 may be cantilever-supported.

Furthermore, the input operating device 3 may be configured so as to be freely displaced from the rear face side to the front face side on the recessed stage 211 of the top face 21 of the housing 2 or may be configured so as to be freely displaced from the rear face side to the front face side by being exposed from on the recessed stage 211 to the outward of the recessed stage 211. The input operating device 3 may be configured so as to be freely displaced vertically between on the recessed stage 211 and above the recessed stage 211 or may be configured so as to be freely pulled out from the inside of the housing 2 to the outside. In addition, among a plurality of displacements described above, two or more of the displacements may be selected and combined. For example, the input operating device 3 may be displaced along the top face 21 of the housing 2 and the angle of inclination of the input operating portion 31 with respect to the top face 21 of the housing 2 may be changed.

The foregoing preferred embodiments are to be considered in all respects as illustrative and not restrictive. The scope of the present invention is defined by the following claims, not by the foregoing embodiments. Further, the scope of the present invention is intended to include the scopes of the claims and all possible changes and modifications within the senses and scopes of equivalents.

What is claimed is:

1. An image forming apparatus comprising:
a housing with a top face;
an input operating device having an input operating portion on an upper face side of the input operating device, being arranged on a front face side of the top face of the housing, and being configured so that a position of the input operating portion can be changed; and
a display device having a display portion on a front face side of the display device, being arranged at a position higher than the top face of the housing and more backward than the input operating device, and being configured so that a position of the display portion can be changed.

2. The image forming apparatus according to claim 1, wherein the input operating device is configured to be freely displaced in a plan view.

3. The image forming apparatus according to claim 1, wherein the input operating device is configured so that an angle of inclination of the input operating portion with respect to the top face of the housing is freely changed.

4. The image forming apparatus according to claim 2, further comprising a support structure that supports the display device and is installed at an end portion of the top face of the housing in a front view,
wherein the input operating device, in the front view, has a first end on a side located far from an installation position of the support structure, and a second end on a side close to the installation position of the support structure; and
wherein the input operating device is configured so that the second end is displaced around the first end as a support point.

5. The image forming apparatus according to claim 2, further comprising a restricting member that restricts an amount of displacement of the input operating device within a predetermined range.

6. The image forming apparatus according to claim 3, further comprising a restricting member that restricts an amount of displacement of the input operating device within a predetermined range.

7. The image forming apparatus according to claim 4, further comprising a restricting member that restricts an amount of displacement of the input operating device within a predetermined range.

8. The image forming apparatus according to claim 5, further comprising a fixing unit that fixes the input operating device at each of a plurality of positions within the predetermined range of the amount of displacement of the input operating device.

9. The image forming apparatus according to claim 6, further comprising a fixing unit that fixes the input operating device at each of a plurality of positions within the predetermined range of the amount of displacement of the input operating device.

10. The image forming apparatus according to claim 7, further comprising a fixing unit that fixes the input operating device at each of a plurality of positions within the predetermined range of the amount of displacement of the input operating device.

11. The image forming apparatus according to claim 4, wherein the support structure comprises:
a support post attached on the top face of the housing;
a support arm pivotally fixed to the support post; and
a pivoting member arranged at a tip of the support arm.

12. The image forming apparatus according to claim 1, wherein the input operating portion includes an array of a plurality of hardware keys.

13. The image forming apparatus according to claim 1, wherein the input operating portion includes a pointing device.

14. The image forming apparatus according to claim 1, wherein the display device is a display provided with a function of a touch panel.
